(19) United States
(12) Patent Application Publication
(10) Pub. No.: US 2024/0359433 A1
(43) Pub. Date: Oct. 31, 2024

(54) COMPOSITION, COMPOSITE MATERIAL AND COPPER CLAD LAMINATE

(71) Applicant: INDUSTRIAL TECHNOLOGY RESEARCH INSTITUTE, Hsinchu (TW)

(72) Inventors: Wen-Chin Lee, Hsinchu City (TW); Meng-Song Yin, Hsinchu City (TW); Man-Chun Yu, New Taipei City (TW); Wei-Ta Yang, Taoyuan City (TW)

(73) Assignee: INDUSTRIAL TECHNOLOGY RESEARCH INSTITUTE, Hsinchu (TW)

(21) Appl. No.: 18/645,952

(22) Filed: Apr. 25, 2024

(30) Foreign Application Priority Data
Apr. 26, 2023 (TW) 112115458

(51) Int. Cl. B32B 15/092

(52) U.S. Cl. CPC B32B 15/092; B32B 2250/03; B32B 2250/40; B32B 2260/021; B32B 2260/046; B32B 2262/101; B32B 2305/08

(57) ABSTRACT

A composition, composite material, and copper clad laminate are provided. The composition includes 100 parts by weight of a compound having two epoxy groups, 20-80 parts by weight of a compound having at least two phenolic hydroxy groups, and 0.01-1.5 parts by weight of an ionic liquid. The ionic liquid is not imidazolium ionic liquid.

### CROSS REFERENCE TO RELATED APPLICATIONS

The application claims priority of Taiwan Patent Application No. 112115458, filed on Apr. 26, 2023, the entirety of which is incorporated by reference herein.

### TECHNICAL FIELD

The disclosure relates to a composition, composite material, and a copper clad laminate employing the same.

### BACKGROUND

Epoxy resin, with its excellent electrical properties, adhesion, and weather resistance, has been widely applied in electronic fields such as electrical insulation, laminates, and semiconductor encapsulation.

In precision applications like IC carrier boards or high-layer circuit board products, there is a particular need for laminated sheets that can shorten the curing time. Laminated sheets used in the printed circuit board (PCB) industry are also known as B-stage prepreg, which is typically made by impregnating glass fiber cloth into resin composition.

However, conventional B-stage prepreg that can be stored at room temperature often exhibits lower reactivity, requiring higher hot-pressing temperatures and longer curing time, leading to increased energy consumption and reduced manufacturing capacity. Additionally, simply increasing the reactivity of B-stage prepreg (e.g., by increasing the curing agent content) can decrease its stability, making it unsuitable for storage at room temperature. Furthermore, storing B-stage prepreg at low temperatures would significantly increase equipment costs and energy consumption, resulting in reducing product reliability due to moisture absorption.

### SUMMARY

According to embodiments of the disclosure, the disclosure provides a composition. The composition includes 100 parts by weight of a compound having two epoxy groups, 20-80 parts by weight of a compound having at least two phenolic hydroxy groups, and 0.01-1.5 parts by weight of ionic liquid.

According to embodiments of the disclosure, the ionic liquid is not an imidazolium ionic liquid.

According to embodiments of the disclosure, the ionic liquid is pyridinium ionic liquid, tetraalkyl phosphonium ionic liquid, trialkyl sulfonium ionic liquid, tetraalkyl ammonium ionic liquid, morpholinium ionic liquid, piperidinium ionic liquid, pyrrolidinium ionic liquid, thiazolium ionic liquid, triazolium ionic liquid, benzimidazolium ionic liquid, isoquinolinium ionic liquid or a combination thereof.

According to embodiments of the disclosure, the disclosure also provides a composite material. The composite material includes a cured product or semi-cured product of the composition of the disclosure and a reinforcing material. It should be noted that, the cured product or semi-cured product may be disposed on the reinforcing material or disposed in the reinforcing material.

According to embodiments of the disclosure, the disclosure also provides a copper clad laminate. The copper clad laminate includes a first copper foil and a film, wherein the film is disposed on the first copper foil. The film includes the composite material of the disclosure, or a product prepared from the composite material of the disclosure via a thermocompression molding process.

### BRIEF DESCRIPTION OF THE DRAWINGS

The present disclosure can be more fully understood by reading the subsequent detailed description and examples with references made to the accompanying drawings, wherein:

FIG. 1 is a schematic view of a copper clad laminate according to an embodiment of the disclosure.

FIG. 2 a schematic view of a copper clad laminate according to another embodiment of the disclosure.

### DETAILED DESCRIPTION OF DISCLOSED EMBODIMENTS

The composition, composite material, and copper clad laminate are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the field.

Moreover, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

It should be noted that the elements or devices in the drawings of the disclosure may be present in any form or configuration known to those skilled in the field. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The drawings described are only schematic and are non-limiting. In the drawings, the size, shape, or thickness of some of the elements may be exaggerated and not drawn on scale for illustrative purposes. The dimensions and the relative dimensions do not correspond to actual location to practice the disclosure. The disclosure will be described with respect to particular embodiments and with reference to certain drawings but the disclosure is not limited thereto.

The disclosure provides a composition, such as a curable composition. In addition to the epoxy compound and the curing agent, the composition of the disclosure further comprises a specific ionic liquid, and each component exists in the composition in appropriate proportions. As a result, a composite material including a cured product or semi-cured product prepared from the composition of the disclosure can simultaneously achieve high storage stability (such as room temperature stability exceeding 90 days) and appropriate reactivity (such as reducing the full curing time to less than 45 minutes at high temperature around 170° C. via thermocompression molding processes), thereby making it highly suitable for preparing copper clad laminates. Additionally, due to the specific combination of components, the composition of the disclosure can effectively achieve the objectives of the disclosure for reducing the amount of ionic liquid to a low range of 0.01 to 1.5 weight percent based on the weight of the epoxy compound. Since the ionic liquid is a relatively expensive component in the materials used for copper clad laminate processes and the composition of the disclosure employs a relatively low amount of the ionic liquid, the costs of copper clad laminate processes can be reduced, making the composition of the disclosure suitable for commercial applications. The embodiments of the disclosure also provide a composite material (such as B-stage prepreg) including the cured or semi-cured product of the aforementioned composition, suitable for preparing copper clad laminates.

According to embodiments of the disclosure, the composition of the disclosure can include 100 parts by weight of a compound having two epoxy groups, 20-80 parts by weight (such as 25 parts by weight, 30 parts by weight, 35 parts by weight, 40 parts by weight, 45 parts by weight, 50 parts by weight, 55 parts by weight, 60 parts by weight, 65 parts by weight, 70 parts by weight, or 75 parts by weight) of a compound having at least two phenolic hydroxy groups, and 0.01-1.5 parts by weight (such as 0.05 parts by weight, 0.1 parts by weight, 0.2 parts by weight, 0.4 parts by weight, 0.6 parts by weight, 0.8 parts by weight, 1.0 parts by weight, 1.2 parts by weight, or 1.4 parts by weight) of the ionic liquid. Namely, the amount of the compound having at least two phenolic hydroxy groups may be 20 wt % to 80 wt %, based on the compound having two epoxy groups. When the amount of compound having at least two phenolic hydroxyl groups is too low, the thermal properties (such as glass transition temperature) and mechanical properties (such as rigidity) of the cured epoxy composition decrease, thereby potentially rendering it unsuitable for manufacturing copper clad laminates. Conversely, when the amount of compound having at least two phenolic hydroxyl groups is too high, the thermal and mechanical properties of the cured epoxy composition similarly decrease, thereby also potentially making it unsuitable for manufacturing copper clad laminates. In addition, the amount of ionic liquid may range from 0.01 wt % to 1.5 wt %, based on the weight of the compound having two epoxy groups. When the amount of ionic liquid is too low, it cannot effectively increase the reactivity of the resulting composite material. Additionally, when the amount of ionic liquid is too high, besides being unable to effectively increase the storage stability of the resulting composite material, it will also significantly increase the manufacturing cost of the composition. According to embodiments of the disclosure, a part of the ionic liquid of the disclosure may effectively increase the reactivity and storage stability of the composition when the ionic liquid is used in amounts ranging from 0.01 wt % to 0.05 wt %.

According to embodiments of the disclosure, in order to force the composite material of the disclosure simultaneously achieves high storage stability (such as room temperature stability exceeding 90 days) and appropriate reactivity, the ionic liquid used in the composition of the disclosure may be pyridinium ionic liquid, tetraalkyl phosphonium ionic liquid, trialkyl sulfonium ionic liquid, tetraalkyl ammonium ionic liquid, morpholinium ionic liquid, piperidinium ionic liquid, pyrrolidinium ionic liquid, thiazolium ionic liquid, triazolium ionic liquid, benzimidazolium ionic liquid, isoquinolinium ionic liquid, or a combination thereof. In addition, in order for the composite material of the disclosure to undergo a thermocompression molding process with a copper foil at relatively low process temperatures, the melting point of the ionic liquid of the disclosure is less than or equal to 180° C.

According to embodiments of the disclosure, the ionic liquid of the disclosure may consist of a cation and an anion, wherein the cation may be pyridinium ion (with a structure of

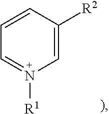

tetraalkyl phosphonium ion (with a structure of

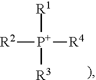

trialkyl sulfonium ion (with a structure of

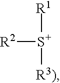

tetraalkyl ammonium ion (with a structure of

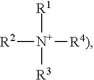

morpholinium ion (with a structure of

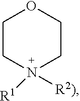

piperidinium ion (with a structure of

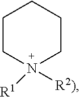

pyrrolidinium ion (with a structure of

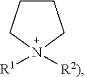

thiazolium ion (with a structure of

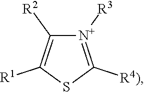

triazolium ion (with a structure of

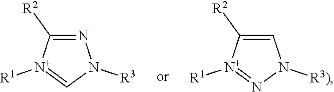

benzimidazolium ion (with a structure of

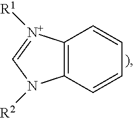

or isoquinolinium ion (with a structure of

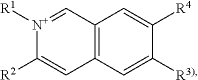

wherein R¹, R², R³, and R⁴ are independently hydrogen, C₁₋₁₄ alkyl group, C₁₋₃ alkylol group, phenyl group or benzyl group. In addition, the anion may be I⁻, Br⁻, Cl⁻, NO₃⁻, SO₄²⁻, CO₃²⁻, ClO₄⁻, BF₄⁻, PF₆⁻, SCN⁻, N(CN)₂⁻;

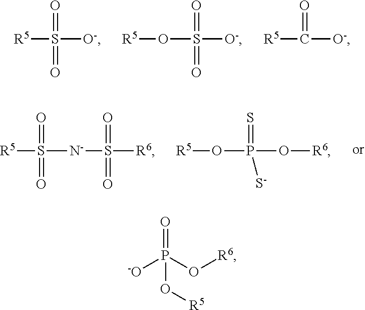

wherein R⁵ and R⁶ are independently hydrogen, fluorine C₁₋₆ alkyl group, or C₁₋₆ fluoroalkyl group.

According to embodiments of the disclosure, the cation of the ionic liquid of the disclosure may be 1-butylpyridinium, tributyl(methyl)phosphonium, tetrabutylphosphonium, triethyl(tetradecyl)phosphonium, trimethylsulfonium, triethylsulfonium, trimethylpropylammonium, tributylmethylammonium, tetramethylammonium, 4-ethyl-4-methylmorpholinium, 1-butyl-1-methylpiperidinium, 1-butyl-1-methylpyrrolidinium, 1-ethyl-3-methylthiazolium, 1-ethyl-4-methyl-1,2,4-triazolium, 1,4-dimethyl-1,2,4-triazolium, methyl-1,2,3-triazolium, 1-butyl-3-methylbenzimidazolium, 1,3-di-tert-butylbenzimidazolium, or 1-butylisoquinolinium.

According to embodiments of the disclosure, C₁₋₁₄ alkyl group may be linear or branched. For example, C₁₋₁₄ alkyl group may be methyl, ethyl, propyl, butyl, pentyl, hexyl, heptyl, octyl, nonyl, decyl group, undecyl, dodecyl, tridecyl, tetradecyl, or an isomer thereof. According to embodiments of the disclosure, C₁₋₆ fluoroalkyl group may be a C₁₋₆ alkyl group which a part of or all hydrogen atoms bonded on the carbon atom are replaced with fluorine atoms, and C₁₋₆ fluoroalkyl group may be linear or branched, such as fluoromethyl, fluoroethyl, fluoropropyl, fluorobutyl, fluoropentyl, fluorohexyl, or an isomer thereof. Herein, fluoromethyl group may be monofluoromethyl group, difluoromethyl group or perfluoromethyl group, and fluoroethyl may be monofluoroethyl group, difluoroethyl group, trifluoroethyl group, tetrafluoroethyl, or perfluoroethyl.

According to embodiments of the disclosure, C₁₋₃ alkylol group may be linear or branched. For example, C₁₋₃ alkylol group may be methylol, ethylol, propylol, or an isomer thereof.

According to embodiments of the disclosure, the ionic liquid of the disclosure used in examples are listed in Table 1.

TABLE 1

| | | | melting |
|---|---|---|---|
| | Name | Chemical structure | point (° C.) |
| Ionic liquid (1) | trimethylpropylammonium bis(trifluoromethanesulfonyl)imide | 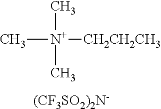 | 19° C. |
| Ionic liquid (2) | tributylmethylammonium bis(trifluoromethanesulfonyl)imide | 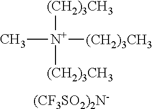 | <0° C. |
| Ionic liquid (3) | 4-ethyl-4-methylmorpholinium bromide | 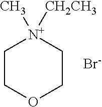 | 177° C. |
| Ionic liquid (4) | triethylsulfonium bis(trifluoromethanesulfonyl)imide | 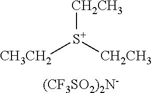 | <0° C. |
| Ionic liquid (5) | tetrabutylphosphonium O,O-diethyl phosphorodithioate | 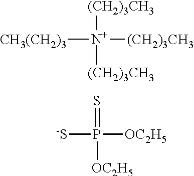 | <0° C. |
| Ionic liquid (6) | 1-butyl-1-methylpyrrolidinium bis(trifluoromethanesulfonyl)imide | 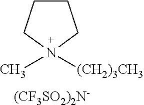 | <0° C. |
| Ionic liquid (7) | 1-butyl-1-methylpiperidinium bis(trifluoromethanesulfonyl)imide | 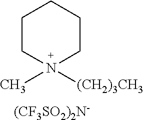 | <0° C. |
| Ionic liquid (8) | 1-butylpyridinium bis(trifluoromethanesulfonyl)imide | 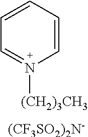 | <0° C. |
| Ionic liquid (9) | 3-benzyl-5-(2-hydroxyethyl)-4- methylthiazolium chloride | 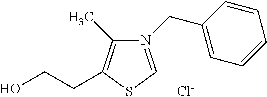 | 144° C. |
| Ionic liquid (10) | 1,3-dimethyl-1H-benzimidazolium iodide | 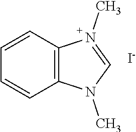 | 142° C. |
| Ionic liquid (11) | 2-propylisoquinolinium bromide | 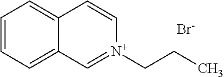 | 146° C. |

According to embodiments of the disclosure, the ionic liquid is not an imidazolium ionic liquid, ensuring that the composite material (such as a B-stage prepreg) prepared from the composition of the disclosure exhibits appropriate reactivity (i.e., the full curing time at high temperature around 170° C. in compression molding process can be reduced to within 45 minutes). According to embodiments of the disclosure, the imidazolium ionic liquid may consist of an imidazolium cation and an anion, wherein the imidazolium cation is

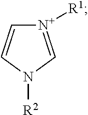

and, the anion is I⁻, Br⁻, Cl⁻, NO₃⁻, SO₄²⁻, CO₃²⁻, ClO₄⁻, BF₄⁻, PF₆⁻, SCN⁻, N(CN)₂⁻,

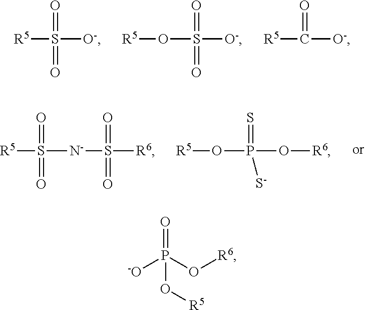

wherein R¹ and R² are independently hydrogen or C₁₋₁₄ alkyl group; and, R⁵ and R⁶ are independently hydrogen, fluorine, C₁₋₆ alkyl group, or C₁₋₆ fluoroalkyl group.

According to embodiments of the disclosure, in order to force the composite material of the disclosure simultaneously achieves high storage stability (such as room temperature stability exceeding 90 days) and appropriate reactivity, the composition of the disclosure does not include an imidazolium ionic liquid.

According to embodiments of the disclosure, the composition of the disclosure employs the compound having two epoxy groups to serve as a resin component. According to embodiments of the disclosure, the compound having two epoxy groups may be cyclohexanedimethanol diglycidyl ether, bisphenol A diglycidyl ether (BADGE), bisphenol F diglycidyl ether (BFDGE), bisphenol S diglycidyl ether, tetrahydrophthalic acid diglycidyl ester, hexahydrophthalic acid diglycidyl ester, 1,4-butanediol diglycidyl ether, 1,6-hexanediol diglycidyl ether, propylene glycol diglycidyl ether, pentaerythritol diglycidyl ether, neopentyl glycol diglycidyl ether, terephthalic acid diglycidyl ester, phthalic acid diglycidyl ester, isophthalic acid diglycidyl ester, resorcinol diglycidyl ether, adipic acid diglycidyl ester, 9,9-bis(4-glycidyloxyphenyl)fluorene, diglycidyl 1,2-Cyclohexanedicarboxylate, ethylene glycol diglycidyl ether, diglycidyl 4-cyclohexene-1,2-dicarboxylate, a combination thereof, or an epoxy resin prepared from at least one of the aforementioned compounds.

According to embodiments of the disclosure, the compound having two epoxy groups may be epoxy resin, such as bisphenol A epoxy resin, bisphenol F epoxy resin, bisphenol S epoxy resin, novolac epoxy resin, naphthalene-based epoxy resin, anthracene-based epoxy resin, bisphenol A diglycidyl ether (BADGE) epoxy resin, ethylene glycol diglycidyl ether epoxy resin, propylene glycol diglycidyl ether epoxy resin, 1,4-butanediol diglycidyl ether epoxy resin, or a combination thereof. According to embodiments of the disclosure, the epoxy resin has a number average molecular weight of about 600 (g/mol) to 2,000,000 (g/mol), such as about 650 (g/mol), 800 (g/mol), 1,000 (g/mol), 1,500 (g/mol), 2,000 (g/mol), 5,000 (g/mol), 8,000 (g/mol), 10,000 (g/mol), 20,000 (g/mol), 30,000 (g/mol), 50,000 (g/mol), 60,000 (g/mol), 80,000 (g/mol), 100,000 (g/mol), 150,000 (g/mol), 200,000 (g/mol), 500,000 (g/mol), 700,000 (g/mol), 1,000,000 (g/mol), 1,500,000 (g/mol), or 1,800,000 (g/mol). The number average molecular weight (Mn) of the epoxy resin of the disclosure can be determined by gel permeation chromatography (GPC) based on a polystyrene calibration curve.

According to embodiments of the disclosure, in addition to the compound having two epoxy groups, the composition of the disclosure further includes other resin components. For example, the other resin components may include a compound with three or more than three epoxy groups, polyolefin resin, cyanate resin, phenol resin, novolak resin, polystyrene resin, styrene-butadiene copolymer resin, polyamide resin, polyimide resin, maleimide resin, bismaleimide resin, polyphenylene ether resin, or compounds used to prepare the above resins.

According to embodiments of the disclosure, in addition to the compound having two epoxy groups, the composition of the disclosure may not include other resin components.

According to embodiments of the disclosure, the compound having at least two phenolic hydroxy groups of the disclosure can serve as a curing agent, wherein the phenolic hydroxy group can react with the compound having two epoxy groups of the disclosure.

According to embodiments of the disclosure, the compound having at least two phenolic hydroxy groups of the disclosure may be a polyphenol compound, such as phenolic novolak resin, cresol novolak resin, bisphenol novolak resin, terpene-modified phenolic resin, dicyclopentadiene-modified phenolic resin, p-xylene-modified phenolic resin, phenol aralkyl resin, naphthol aralkyl resin, triphenolmethane phenol resin, polyvinyl phenol resin, or a combination thereof.

According to embodiments of the disclosure, the compound having at least two phenolic hydroxy groups of the disclosure may include a commercial phenolic curing agent, such as curing agents commercially available from Air Water (with trade numbers of HE-610C, 620C); curing agents commercially available from DIC (with trade numbers of TD-2131, TD-2106, TD-2093, TD-2091, TD-2090, VH-4150, VH-4170, KH-6021, KA-1160, KA-1163, KA-1165, TD-2093-60M, TD-2090-60M, LF-6161, LF-4871, LA-7052, LA-7054, LA-7751, LA-1356, LA-3018-50P, EXB-9854); curing agents commercially available from NIPPON STEEL & SUMIKIN CHEMICAL CO., LTD. (with trade numbers of SN-170, SN180, SN190, SN475, SN485, SN495, SN375, SN395); curing agents commercially available from JX Metals Corporation (with trade number of DPP); curing agents commercially available from Meiwa Plastic Industries, Ltd. (with trade numbers of HF-1M, HF-3M, HF-4M, H-4, DL-92, MEH-7500, MEH-7600-4H, MEH-7800, MEH-7851, MEH-7851-4H, MEH-8000H, MEH-8005); or curing agents commercially available from Mitsui Chemicals, Inc. (with trade numbers of XL, XLC, RN, RS, RX), but are not limited to.

According to embodiments of the disclosure, the composition of the disclosure, in addition to the compound having at least two phenolic hydroxy groups, may further include other curing agents for use in concert with the compound having at least two phenolic hydroxy groups. The other curing agents may include commonly known curing agents used for epoxy resin compositions, such as isocyanate curing agents, amine-based curing agents, anhydride curing agents, or a combination thereof.

According to embodiments of the disclosure, the composition of the disclosure may not include other curing agents (such as curing agents used for epoxy resin composition) except the compound having at least two phenolic hydroxy groups.

According to embodiments of the disclosure, in order to further reduce the amount of ionic liquid in the composition, the composition of the disclosure may further include an imidazole compound, wherein the imidazole compound is not an ionic compound. The amount of the imidazole compound may be 0.01 parts by weight to 1 part by weight, wherein the compound having two epoxy groups is used in a amount of 100 parts by weight. In addition to the imidazole compound, a person skilled in the field knows that a curing accelerator can further reduce the amount of ionic liquid in the composition.

According to embodiments of the disclosure, the imidazole compound may be

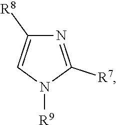

wherein R⁷, R⁸ and R⁹ are independently hydrogen, C₁₋₆ alkyl group, C₅₋₇ cycloalkyl group (such as cyclopentyl group, cyclohexyl group, or cycloheptyl group, or phenyl group). For example, the imidazole compound may be 3,5-dimethylpyrazole, imidazole, 2-methylimidazole, 2-ethyl-4-methylimidazole, 2-phenylimidazole, 2-phenyl-4-methylimidazole, 2-cyclohexyl imidazole, 2-cyclohexyl-4-methylimidazole, or a combination thereof.

According to embodiments of the disclosure, the composition of the disclosure may further include a solvent, forcing the compound having two epoxy groups, the compound having at least two phenolic hydroxy groups, and the ionic liquid being uniformly dispersed in the solvent. Therefore, the compound having two epoxy groups, the compound having at least two phenolic hydroxy groups, and the ionic liquid may be dispersed in the solvent.

According to embodiments of the disclosure, the solid content of the composition is not limited and can be optionally adjusted by a person skilled in the field depending on the application. According to embodiments of the disclosure, the solid content of the composition may range from about 10 wt % to 90 wt % (such as about 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, or 85 wt %). Herein, the solid content means a percentage of the total component weight of the composition except the solvent, based on the total weight of the composition.

According to embodiments of the disclosure, in the composition of the disclosure, the compound having two epoxy groups has a weight percentage of 55.6 wt % to 83.3 wt %, based on the weight of the total components of the composition except solvent.

According to embodiments of the disclosure, the solvent may be an aromatic hydrocarbon solvent, alcohol solvent, ether solvent, ketone solvent, ester solvent, nitrogen-containing solvent, or a combination thereof.

According to embodiments of the disclosure, the solvent may be benzene, toluene, xylene, ethylbenzene, diethylbenzene, trimethylbenzene, triethylbenzene, cyclohexane, cyclohexene, decahydronaphthalene, dipentene, pentane, hexane, heptane, octane, nonane, decane, ethyl cyclohexane, methyl cyclohexane, p-menthane, dipropyl ether, dibutyl ether, anisole, butyl acetate, pentyl acetate, methyl isobutyl ketone (MEK), cyclohexylbenzene, cyclohexanone, cyclopentanone (CPN), triglyme, 1,3-dimethyl-2-imidazolidinone (DMI), N-methyl-2-pyrrolidone (NMP), methyl ethyl ketone (MEK), N,N-dimethylacetamide (DMAc), γ-butyrolactone (GBL), N,N-dimethylformamide (DMF), propylene glycol methyl ether acetate (PGMEA), dimethyl sulfoxide (DMSO), or a combination thereof.

According to embodiments of the disclosure, the composition further includes an additive, wherein the additive may be a filler (such as silicon oxide, aluminum oxide, titanium oxide, zirconium oxide, chromium oxide, vanadium oxide, molybdenum oxide, silicon nitride, boron nitride, aluminum nitride, tungsten nitride, titanium nitride, zinc nitride, silicon carbide, tungsten carbide, boron carbide, aluminum carbide, molybdenum carbide, titanium carbide, aluminum boride, titanium boride, magnesium boride, cobalt boride, polytetrafluoroethylene (PTFE), or a combination thereof), colorant, flame retardant, or a combination thereof. According to embodiments of the disclosure, the amount of the filler may be 200 wt % to 500 wt %, based on the weight of the compound having two epoxy groups. In addition, the particle size of the filler is not limited and can be optionally modified by a person skilled in the field. For example, the filler has an average particle size of 1 nm to 30 μm.

According to embodiments of the disclosure, the disclosure also provides a composite material. The composite material may include a cured product or semi-cured product of the aforementioned composition; and a reinforcing material, wherein the cured product or semi-cured product is disposed on the reinforcing material or disposed in the reinforcing material. According to embodiments of the disclosure, the reinforcing material may be plant fiber, glass, ceramic, carbon material, polymer, or a combination thereof. In addition, the forms of the reinforcing material may be fiber, powder, sheet-shaped material, textile, or a combination thereof. According to embodiments of the disclosure, the composite material may be a laminated sheet, such as B-stage prepreg applied in the printed circuit board (PCB) manufacturing process. The method for preparing the composite material may include impregnating the reinforcing material into the composition of the disclosure. Next, the composition is subjected to a curing or semi-curing process, obtaining the composite material.

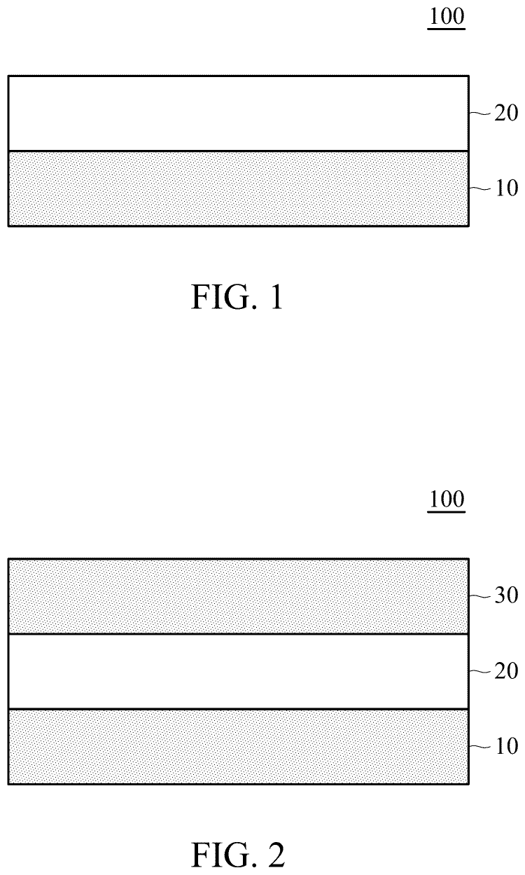

According to embodiments of the disclosure, the disclosure also provides a copper clad laminate. FIG. 1 is a schematic view of a copper clad laminate 100 according to an embodiment of the disclosure. As shown in FIG. 1, the copper clad laminate 100 includes a first copper foil 10, and a film 20, wherein the film 20 is disposed on the first copper foil 10. According to embodiments of the disclosure, the film 20 includes the composite material of the disclosure, or the product obtained by subjecting the composite material (such as B-stage prepreg) to a baking process. According to embodiments of the disclosure, the first copper foil 10 directly contacts the film 20. As shown in FIG. 2, the copper clad laminate 100 of the disclosure may further include a second copper foil 30, wherein the film 20 is disposed between the first copper foil 10 and the second copper foil 30.

According to embodiments of the disclosure, the copper clad laminate of the disclosure may be prepared by subjecting the composite material of the disclosure and copper foil to a thermocompression molding process. The method for preparing the copper clad laminate of the disclosure may include the following steps. First, a reinforcing material is impregnated into the composition of the disclosure and then the reinforcing material is subjected to a semi-curing baking process to obtain the composite material. Next, the composite material is disposed between a first copper foil and a second copper foil to create a stacked structure. Next, the stacked structure is subjected to a thermocompression molding process (such as thermocompression molding process performed by a vacuum compression molding machine) to form the copper clad laminate. According to embodiments of the disclosure, the temperature during the high temperature stage of the thermocompression molding process may range from about 140° C. to 170° C., and the curing time during the high-temperature stage can be controlled to be within 45 minutes.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### Example

### Preparation of Composition

### Example 1

100 parts by weight of bisphenol A diglycidyl ether (BADGE), 56 parts by weight of trisphenol methane novolak resin (with a trade number of MEH-7500, commercially available from Meiwa Plastic Industries, Ltd.) (having a hydroxyl equivalent of 95 g/Eq), 0.87 parts by weight of Ionic liquid (1) (trimethylpropylammonium bis(trifluoromethanesulfonyl)imide), and 300 parts by weight of silicon dioxide powder (with an average particle size of 1.9 μm) were added into 195 parts by weight of methyl ethyl ketone (MEK), and then the result was mixed at room temperature for 60 minutes, obtaining Composition (1).

### Example 2

Example 2 was performed in the same manner as in Example 1, except that Ionic liquid (1) was replaced with Ionic liquid (2) (tributylmethylammonium bis(trifluoromethanesulfonyl)imide), and the amount of ionic liquid was increased from 0.87 parts by weight to 1.09 parts by weight, obtaining Composition (2).

### Example 3

Example 3 was performed in the same manner as in Example 1, except that Ionic liquid (1) was replaced with Ionic liquid (3) (4-ethyl-4-methylmorpholinium bromide), and the amount of ionic liquid was reduced from 0.87 parts by weight to 0.48 parts by weight, obtaining Composition (3).

### Example 4

Example 4 was performed in the same manner as in Example 1, except that Ionic liquid (1) was replaced with Ionic liquid (4) (triethylsulfonium bis(trifluoromethanesulfonyl)imide), and the amount of ionic liquid was increased from 0.87 parts by weight to 0.91 parts by weight, obtaining Composition (4).

### Example 5

Example 5 was performed in the same manner as in Example 1, except that Ionic liquid (1) was replaced with Ionic liquid (5) (tetrabutylphosphonium 0,0-diethyl phosphorodithioate), and the amount of ionic liquid was increased from 0.87 parts by weight to 1.01 parts by weight, obtaining Composition (5).

### Example 6

Example 6 was performed in the same manner as in Example 1, except that Ionic liquid (1) was replaced with Ionic liquid (6) (1-butyl-1-methylpyrrolidinium bis(trifluoromethanesulfonyl)imide), and the amount of ionic liquid was increased from 0.87 parts by weight to 0.96 parts by weight, obtaining Composition (6).

### Example 7

Example 7 was performed in the same manner as in Example 1, except that Ionic liquid (1) was replaced with Ionic liquid (7) (1-butyl-1-methylpiperidinium bis(trifluoromethanesulfonyl)imide), the amount of ionic liquid was increased from 0.87 parts by weight to 0.99 parts by weight, and no silicon dioxide powder was added, obtaining Composition (7).

### Example 8

Example 8 was performed in the same manner as in Example 1, except that Ionic liquid (1) was replaced with Ionic liquid (8) (1-butylpyridinium bis(trifluoromethanesulfonyl)imide), the amount of ionic liquid was increased from 0.87 parts by weight to 0.94 parts by weight, and no silicon dioxide powder was added, obtaining Composition (8).

The components and amounts of Compositions (1)-(8) are shown in Table 2.

TABLE 2

| | bisphenol A | | trisphenol | | |
|---|---|---|---|---|---|
| | diglycidyl | | methane | | methyl |
| | ether | | novolak | silicon | ethyl |
| | (BADGE) | ionic liquid/ | resin | dioxide | ketone |
| | (parts by | parts by | (parts by | (parts by | (parts by |
| | weight) | weight | weight) | weight) | weight) |
| Composition | 100 | Ionic liquid | 56 | 300 | 195 |
| (1) | | (1)/0.87 | | | |
| Composition | 100 | Ionic liquid | 56 | 300 | 195 |
| (2) | | (2)/1.09 | | | |
| Composition | 100 | Ionic liquid | 56 | 300 | 195 |
| (3) | | (3)/0.48 | | | |
| Composition | 100 | Ionic liquid | 56 | 300 | 195 |
| (4) | | (4)/0.91 | | | |
| Composition | 100 | Ionic liquid | 56 | 300 | 195 |
| (5) | | (5)/1.01 | | | |
| Composition | 100 | Ionic liquid | 56 | 300 | 195 |
| (6) | | (6)/0.96 | | | |
| Composition | 100 | Ionic liquid | 56 | — | 195 |
| (7) | | (7)/0.99 | | | |
| Composition | 100 | Ionic liquid | 56 | — | 195 |
| (8) | | (8)/0.94 | | | |

### Example 9

Example 9 was performed in the same manner as in Example 1, except that the amount of ionic liquid was reduced from 0.87 parts by weight to 0.43 parts by weight, and 0.075 parts by weight of 2-ethyl-4-methylimidazole was added, obtaining Composition (9).

### Example 10

Example 10 was performed in the same manner as in Example 2, except that the amount of ionic liquid was reduced from 1.09 parts by weight to 0.54 parts by weight, and 0.075 parts by weight of 2-ethyl-4-methylimidazole was added, obtaining Composition (10).

### Example 11

Example 11 was performed in the same manner as in Example 3, except that 0.075 parts by weight of 2-ethyl-4-methylimidazole was added, obtaining Composition (11).

### Example 12

Example 12 was performed in the same manner as in Example 4, except that the amount of ionic liquid was reduced from 0.91 parts by weight to 0.45 parts by weight, and 0.075 parts by weight of 2-ethyl-4-methylimidazole was added, obtaining Composition (12).

### Example 13

Example 13 was performed in the same manner as in Example 5, except that the amount of ionic liquid was reduced from 1.01 parts by weight to 0.5 parts by weight, and 0.075 parts by weight of 2-ethyl-4-methylimidazole was added, obtaining Composition (13).

### Example 14

Example 14 was performed in the same manner as in Example 6, except that the amount of ionic liquid was reduced from 0.96 parts by weight to 0.48 parts by weight, and 0.075 parts by weight of 2-ethyl-4-methylimidazole was added, obtaining Composition (14).

### Example 15

Example 15 was performed in the same manner as in Example 7 except that the amount of ionic liquid was reduced from 0.99 parts by weight to 0.5 parts by weight, and 0.075 parts by weight of 2-ethyl-4-methylimidazole was added, obtaining Composition (15).

### Example 16

Example 16 was performed in the same manner as in Example 8 except that the amount of ionic liquid was reduced from 0.94 parts by weight to 0.47 parts by weight, and 0.075 parts by weight of 2-ethyl-4-methylimidazole was added, obtaining Composition (16).

The components and amounts of Compositions (9)-(16) are shown in Table 3.

TABLE 3

| | bisphenol A | | | | | |
|---|---|---|---|---|---|---|
| | diglycidyl | | | trisphenol | | methyl |
| | ether | | 2-ethyl-4- | methane | silicon | ethyl |
| | (BADGE) | Ionic liquid/ | methylimidazole | novolak | dioxide | ketone |
| | (parts by | parts by | (parts by | resin (parts | (parts by | (parts by |
| | weight) | weight | weight) | by weight) | weight) | weight) |
| Composition | 100 | Ionic liquid | 0.075 | 56 | 300 | 195 |
| (9) | | (1)/0.43 | | | | |
| Composition | 100 | Ionic liquid | 0.075 | 56 | 300 | 195 |
| (10) | | (2)/0.54 | | | | |
| Composition | 100 | Ionic liquid | 0.075 | 56 | 300 | 195 |
| (11) | | (3)/0.48 | | | | |
| Composition | 100 | Ionic liquid | 0.075 | 56 | 300 | 195 |
| (12) | | (4)/0.45 | | | | |
| Composition | 100 | Ionic liquid | 0.075 | 56 | 300 | 195 |
| (13) | | (5)/0.5 | | | | |
| Composition | 100 | Ionic liquid | 0.075 | 56 | 300 | 195 |
| (14) | | (6)/0.48 | | | | |
| Composition | 100 | Ionic liquid | 0.075 | 56 | — | 195 |
| (15) | | (7)/0.5 | | | | |
| Composition | 100 | Ionic liquid | 0.075 | 56 | — | 195 |
| (16) | | (8)/0.47 | | | | |

### Comparative Example 1

100 parts by weight of bisphenol A diglycidyl ether (BADGE), 56 parts by weight of trisphenol methane novolak resin (with a trade number of MEH-7500, commercially available from Meiwa Plastic Industries, Ltd.) (having a hydroxyl equivalent of 95 g/Eq), 0.25 parts by weight of 2-ethyl-4-methylimidazole, and 300 parts by weight of silicon dioxide powder (with an average particle size of 1.9 μm) were added into 195 parts by weight of methyl ethyl ketone (MEK), and then the result was mixed at room temperature for 60 minutes, obtaining Composition (17).

### Comparative Example 2

100 parts by weight of bisphenol A diglycidyl ether (BADGE), 56 parts by weight of trisphenol methane novolak resin (with a trade number of MEH-7500, commercially available from Meiwa Plastic Industries, Ltd.) (having a hydroxyl equivalent of 95 g/Eq), 0.2 parts by weight of N,N′-dimethylurea, and 300 parts by weight of silicon dioxide powder (with an average particle size of 1.9 μm) were added into 195 parts by weight of methyl ethyl ketone (MEK), and then the result was mixed at room temperature for 60 minutes, obtaining Composition (18).

### Comparative Example 3

100 parts by weight of bisphenol A diglycidyl ether (BADGE), 56 parts by weight of trisphenol methane novolak resin (with a trade number of MEH-7500, commercially available from Meiwa Plastic Industries, Ltd.) (having a hydroxyl equivalent of 95 g/Eq), 0.5 parts by weight of 1,3-dimethylimidazolium dimethyl phosphate, and 300 parts by weight of silicon dioxide powder (with an average particle size of 1.9 μm) were added into 195 parts by weight of methyl ethyl ketone (MEK), and then the result was mixed at room temperature for 60 minutes, obtaining Composition (19).

### Comparative Example 4

100 parts by weight of bisphenol A diglycidyl ether (BADGE), 56 parts by weight of trisphenol methane novolak resin (with a trade number of MEH-7500, commercially available from Meiwa Plastic Industries, Ltd.) (having a hydroxyl equivalent of 95 g/Eq), 0.4 parts by weight of 1-ethyl-3-methylimidazolium dicyanamide, and 300 parts by weight of silicon dioxide powder (with an average particle size of 1.9 μm) were added into 195 parts by weight of methyl ethyl ketone (MEK), and then the result was mixed at room temperature for 60 minutes, obtaining Composition (20).

### Comparative Example 5

100 parts by weight of bisphenol A diglycidyl ether (BADGE), 56 parts by weight of trisphenol methane novolak resin (with a trade number of MEH-7500, commercially available from Meiwa Plastic Industries, Ltd.) (having a hydroxyl equivalent of 95 g/Eq), 0.39 parts by weight of 1-ethyl-3-methylimidazolium acetate, and 300 parts by weight of silicon dioxide powder (with an average particle size of 1.9 μm) were added into 195 parts by weight of methyl ethyl ketone (MEK), and then the result was mixed at room temperature for 60 minutes, obtaining Composition (21).

The components and amounts of Compositions (17)-(21) are shown in Table 4.

TABLE 4

| | bisphenol A | | | | | | |
|---|---|---|---|---|---|---|---|
| | diglycidyl | | | trisphenol | | | |
| | ether | | 2-ethyl-4- | methane | silicon | methyl ethyl | |
| | (BADGE) | | methylimidazole | novolak | dioxide | ketone | |
| | (parts by | ionic liquid/ | (parts by | resin (parts | (parts by | (parts by | |
| | weight) | parts by weight | weight) | by weight) | weight) | weight) | [symbol] |
| Composition | 100 | — | 0.25 | 56 | 300 | 195 | [symbol] |
| (17) | | | | | | | |

| | bisphenol A | | | | | | |
|---|---|---|---|---|---|---|---|
| | diglycidyl | | | trisphenol | | methyl | |
| | ether | | N,N′- | methane | silicon | ethyl | |
| | (BADGE) | | dimethylurea | novolak | dioxide | ketone | |
| | (parts by | ionic liquid/ | (parts by | resin (parts | (parts by | (parts by | |
| | weight) | parts by weight | weight) | by weight) | weight) | weight) | [symbol] |
| Composition | 100 | — | 0.2 | 56 | 300 | 195 | [symbol] |
| (18) | | | | | | | |
| Composition | 100 | 1,3-dimethyl- | — | 56 | 300 | 195 | [symbol] |
| (19) | | imidazolium | | | | | |
| | | dimethyl | | | | | |
| | | phosphate/0.5 | | | | | |
| Composition | 100 | 1-ethyl-3-methyl- | — | 56 | 300 | 195 | [symbol] |
| (20) | | imidazolium | | | | | |
| | | dicyanamide/0.4 | | | | | |
| Composition | 100 | 1-ethyl-3-methyl- | — | 56 | 300 | 195 | [symbol] |
| (21) | | imidazolium | | | | | |
| | | acetate/0.39 | | | | | |

[symbol]

indicates data missing or illegible when filed

### B-Stage Prepreg

A piece of fiberglass cloth (with a trade number of E-glass style 2116, commercially available from Taiwanglass Co.) was individually impregnated into Compositions (1)-(8) and compositions (17)-(21). After impregnation, the fiberglass cloth was baked at 160° C. to obtain B-stage prepregs (1)-(13) and the time required to form the B-stage prepreg was recorded (shown in Table 5).

Next, the room temperature storage life of the obtained B-stage prepregs (1)-(13) were evaluated, and the results are shown in Table 5. The evaluation of the room temperature storage life of the B-stage prepregs was conducted as following. The B-stage prepregs were stored at room temperature (28±3° C.). Next, on the 1st day, 30^{th} day, 60^{th} day, 90^{th} day, 100^{th} day, 120^{th} day, 180^{th} day, and 270^{th} day after manufacturing, the copper clad laminates prepared from the B-stage prepregs were tested with a method according to IPC-TM-650 to determine their room temperature storage life.

Next, the B-stage prepregs (1)-(13) were individually disposed between two pieces of copper foil to obtain Stacked structures (1)-(13). Then, the stacked structures were subjected to a thermocompression molding process via a vacuum compression molding machine (with a temperature of about 170° C. at the high-temperature stage) to form Copper clad laminates (1)-(13). The time required for curing the prepregs was recorded (as shown in Table 5).

TABLE 5

| | time required | room temperature | time required |
|---|---|---|---|
| | to form the | storage life of | for curing |
| | B-stage prepreg | B-stage prepreg | the prepreg |
| | (minutes) | (days) | (minutes) |
| Composition (1) | 3 | 90 | 30 |
| Composition (2) | 3 | 90 | 30 |
| Composition (3) | 6.5 | 180 | 45 |
| Composition (4) | 5 | 120 | 45 |
| Composition (5) | 3.5 | 120 | 30 |
| Composition (6) | 4 | 100 | 35 |
| Composition (7) | 4 | 90 | 40 |
| Composition (8) | 5 | 100 | 40 |
| Composition (17) | 1.5 | 30 | 40 |
| Composition (18) | >10 | 270 | 105 |
| Composition (19) | 6.5 | 180 | 55 |
| Composition (20) | 6 | 180 | 50 |
| Composition (21) | 6 | 180 | 50 |

As shown in Table 5, the compositions of the disclosure can form B-stage prepregs with fiberglass cloth in 3 to 6.5 minutes. Additionally, the semi-cured prepregs prepared from the compositions of the disclosure simultaneously exhibit high storage stability (such as room temperature stability exceeding 90 days) and appropriate reactivity (capable of curing within 45 minutes at 170° C. via thermocompression molding), thereby making them highly suitable for preparing copper clad laminates. In Comparative Example 1, where Composition (17) used 2-ethyl-4-methylimidazole instead of the ionic liquid of the disclosure, the room temperature storage life of the obtained B-stage prepregs is only 30 days. In Comparative Example 2, where Composition (18) used N,N′-dimethylurea instead of the ionic liquid of the disclosure, the reactivity of the obtained B-stage prepregs is poorer (requiring 105 minutes to cure at 170° C. via thermocompression molding). Furthermore, in Comparative Examples 3-5, where Compositions (19)-(21) used imidazole-type ionic liquids instead of the ionic liquid of the disclosure, the reactivity of the resulting B-stage prepregs is significantly poorer (requiring a curing time greater than 50 minutes at 170° C. via thermocompression molding).

A piece of fiberglass cloth (with a trade number of E-glass style 2116, commercially available from Taiwanglass Co.) was individually impregnated into Compositions (9)-(16). After impregnation, the fiberglass cloth was baked at 160° C. to obtain B-stage prepregs (14)-(21) and the time required to form the B-stage prepreg was recorded (shown in Table 6).

Next, the room temperature storage life of the obtained B-stage prepregs (14)-(21) were evaluated, and the results are shown in Table 6. Next, the B-stage prepregs (14)-(21) were individually disposed between two pieces of copper foil to obtain Stacked structures (14)-(21). Then, the stacked structures were subjected to a thermocompression molding process via a vacuum compression molding machine (with a temperature of about 170° C. at the high-temperature stage) to form Copper clad laminates (14)-(21). The time required for curing the prepregs was recorded (as shown in Table 6).

TABLE 6

| | time required | room temperature | time required |
|---|---|---|---|
| | to form the | storage life of | for curing |
| | B-stage prepreg | B-stage prepreg | the prepreg |
| | (minutes) | (days) | (minutes) |
| Composition (9) | 3.5 | 150 | 35 |
| Composition (10) | 3.5 | 150 | 35 |
| Composition (11) | 4.5 | 180 | 40 |
| Composition (12) | 4.5 | 180 | 40 |
| Composition (13) | 4 | 180 | 30 |
| Composition (14) | 4.5 | 180 | 30 |
| Composition (15) | 4 | 150 | 35 |
| Composition (16) | 4 | 180 | 30 |

It can be observed that when further adding imidazole compounds to the composition of the disclosure, the amount of ionic liquid can be reduced while obtaining B-stage prepregs that exhibit good room temperature storage stability and appropriate reactivity.

Accordingly, the components of the composition of the disclosure exist in optimized proportions within the composition. As a result, the semi-cured product of the composite material prepared from the composition of the disclosure simultaneously exhibits high storage stability (such as room temperature stability exceeding 90 days) and appropriate reactivity (such as reducing the full curing time to less than 45 minutes at high temperature stage of 170° C. via thermocompression molding), thereby making it highly suitable for preparing copper clad laminates.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A composition, comprising:
100 parts by weight of a compound having two epoxy groups;
20-80 parts by weight of a compound having at least two phenolic hydroxy groups; and
0.01-1.5 parts by weight of an ionic liquid, wherein the ionic liquid is pyridinium ionic liquid, tetraalkyl phosphonium ionic liquid, trialkyl sulfonium ionic liquid, tetraalkyl ammonium ionic liquid, morpholinium ionic liquid, piperidinium ionic liquid, pyrrolidinium ionic liquid, thiazolium ionic liquid, triazolium ionic liquid, benzimidazolium ionic liquid, isoquinolinium ionic liquid, or a combination thereof.

2. The composition as claimed in claim 1, wherein the compound having two epoxy groups is cyclohexanedimethanol diglycidyl ether, bisphenol A diglycidyl ether (BADGE), bisphenol F diglycidyl ether (BFDGE), bisphenol S diglycidyl ether, tetrahydrophthalic acid diglycidyl ester, hexahydrophthalic acid diglycidyl ester, 1,4-butanediol diglycidyl ether, 1,6-hexanediol diglycidyl ether, propylene glycol diglycidyl ether, pentaerythritol diglycidyl ether, neopentyl glycol diglycidyl ether, terephthalic acid diglycidyl ester, phthalic acid diglycidyl ester, isophthalic acid diglycidyl ester, resorcinol diglycidyl ether, adipic acid diglycidyl ester, 9,9-bis(4-glycidyloxyphenyl)fluorene, diglycidyl 1,2-cyclohexanedicarboxylate, ethylene glycol diglycidyl ether, diglycidyl 4-cyclohexene-1,2-dicarboxylate, a combination thereof, or an epoxy resin prepared from at least one of the aforementioned compounds.

3. The composition as claimed in claim 1, wherein the compound having at least two phenolic hydroxy groups is phenolic novolak resin, cresol novolak resin, bisphenol novolak resin, terpene-modified phenolic resin, dicyclopentadiene-modified phenolic resin, p-xylene-modified phenolic resin, phenol aralkyl resin, naphthol aralkyl resin, triphenolmethane phenol resin, polyvinyl phenol resin, or a combination thereof.

4. The composition as claimed in claim 1, wherein the ionic liquid consists of a cation and an anion, wherein the cation is 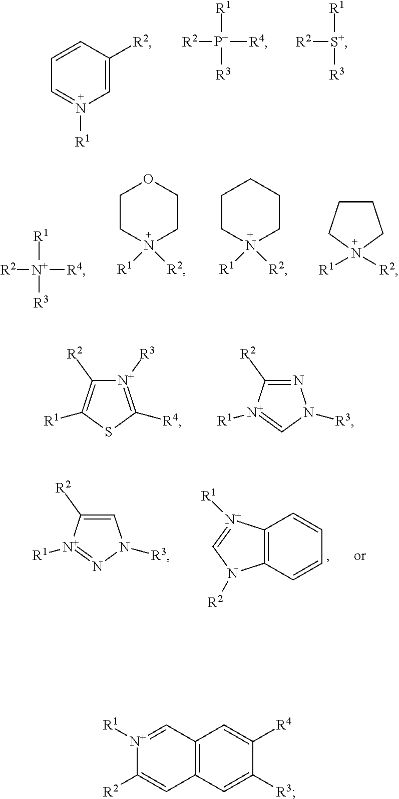
and, the anion is I⁻, Br⁻, Cl⁻, NO₃⁻, SO₄²⁻,
CO₃²⁻, ClO₄⁻, BF₄⁻, PF₆⁻, SCN⁻, N(CN)₂⁻, 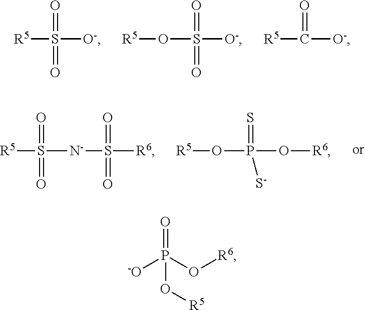
wherein R¹, R², R³, and R⁴ are independently hydrogen, C₁₋₁₄ alkyl group, C₁₋₃ alkylol group, phenyl group or benzyl group; and, R⁵ and R⁶ are independently hydrogen, fluorine, C₁₋₆ alkyl group, or C₁₋₆ fluoroalkyl group.

5. The composition as claimed in claim 1, further comprising:
200 to 500 parts by weight of a filler.

6. The composition as claimed in claim 5, wherein the filler comprises silicon oxide, aluminum oxide, titanium oxide, zirconium oxide, chromium oxide, vanadium oxide, molybdenum oxide, silicon nitride, boron nitride, aluminum nitride, tungsten nitride, titanium nitride, zinc nitride, silicon carbide, tungsten carbide, boron carbide, aluminum carbide, molybdenum carbide, titanium carbide, aluminum boride, titanium boride, magnesium boride, cobalt boride, polytetrafluoroethylene (PTFE), or a combination thereof.

7. The composition as claimed in claim 1, further comprising:
0.01-1 parts by weight of an imidazole compound.

8. The composition as claimed in claim 7, wherein the imidazole compound is 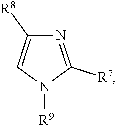
wherein R⁷, R⁸ and R⁹ are independently hydrogen or C₁₋₆ alkyl group.

9. A composite material, comprising:
a cured product or semi-cured product of the composition as claimed in claim 1; and
a reinforcing material, wherein the cured product or semi-cured product is disposed on the reinforcing material or disposed in the reinforcing material.

10. The composite material as claimed in claim 9, wherein the reinforcing material is plant fiber, glass fiber, ceramic, carbon material, polymer, or a combination thereof.

11. A copper clad laminate, comprising:
a first copper foil; and
a film disposed on the first copper foil, wherein the film comprises the composite material as claimed in claim 9, or a product which is made from the composite material.

12. The copper clad laminate as claimed in claim 11, further comprising:
a second copper foil, wherein the film is disposed between the first copper foil and the second copper foil.
